(19) United States
(12) Patent Application Publication
(10) Pub. No.: US 2026/0290013 A1
(43) Pub. Date: Sep. 24, 2026

(54) METHOD AND SYSTEM FOR DETECTING GOLF BALL

(71) Applicant: CREATZ INC., Suwon-si Gyeonggi-do (KR)

(72) Inventors: Hyeon jong CHO, Seoul (KR); Dong sup JIN, Ulsan (KR); Young ho SUK, Seongnam-si Gyeonggi-do (KR)

(73) Assignee: CREATZ INC., Suwon-si Gyeonggi-do (KR)

(21) Appl. No.: 19/574,759

(22) Filed: Mar. 23, 2026

(30) Foreign Application Priority Data
Mar. 24, 2025 (KR) 10-2025-0037530

(51) Int. Cl. G06V 20/40; A63B 24/00; G06V 10/12; G06V 10/764; A63B 102/32

(52) U.S. Cl. CPC G06V 20/42; A63B 24/0021; G06V 10/12; G06V 10/764; A63B 2024/0053; A63B 2102/32

(57) ABSTRACT

Provided is a method for determining whether a target object in a video is a golf ball. The method includes performing a primary determination of whether a target object is a golf ball with respect to a first area of a video through an object recognition model; performing a secondary determination of whether the target object is a golf ball on the basis of a shape of the target object with respect to a second area set on the basis of the target object primarily determined to be a golf ball; and performing a final determination of whether the target object is a golf ball with reference to results of the primary determination and the secondary determination.

### CROSS-REFERENCE TO RELATED APPLICATION

This application claims priority to Korean Patent Application No. 10-2025-0037530 filed on March 24, 2025, the entire contents of which are herein incorporated by reference.

### FIELD OF THE INVENTION

The present invention relates to a method and system for detecting a golf ball.

### BACKGROUND

In various methods and devices for assisting golf play or practice, including virtual golf simulations or golf practice aids on actual courses, accurately recognizing a golf ball is an essential element for providing an optimal playing environment and giving accurate feedback to the user.

However, since conventional methods for golf ball recognition or detection mostly detect a golf ball by using features related to the shape of the golf ball or a brightness difference between a white golf ball and surrounding dark artificial turf, surrounding objects that are similar in shape to a golf ball, such as golf shoes or a club head, or objects like golf shoes that are brighter than their surroundings and have a similar brightness to a golf ball, are often misrecognized as the golf ball. In particular, there are many issues with decreased recognition accuracy, such as failing to properly detect the golf ball when it is partially obscured by grass or the like outdoors.

Meanwhile, conventional methods using deep learning-based learning models such as YOLO (You Only Look Once) for object recognition have been introduced. However, recognition accuracy drops sharply if the amount of training is insufficient, and even with sufficiently trained models, issues with the quality of training data or model overfitting often lead to low golf ball detection accuracy.

In this connection, the inventor(s) present an object recognition technique capable of maximizing golf ball detection accuracy by complementarily using a learning model for performing object recognition and a detection method for recognizing a golf ball on the basis of its shape.

### SUMMARY OF THE INVENTION

One object of the present invention is to solve all the above-described problems in the prior art.

Another object of the invention is to perform a primary determination of whether a target object is a golf ball with respect to a first area of a video through an object recognition model, perform a secondary determination of whether the target object is a golf ball on the basis of a shape of the target object with respect to a second area set on the basis of the target object primarily determined to be a golf ball, and perform a final determination of whether the target object is a golf ball with reference to results of the primary determination and the secondary determination.

Another object of the invention is to detect a golf ball with high accuracy and without errors by complementarily using a learning model for performing object recognition and a detection method for recognizing a golf ball on the basis of its shape, thereby providing a user with an effective golf practice means and the best possible golf play experience.

The representative configurations of the invention to achieve the above objects are described below.

According to one aspect of the invention, there is provided a method comprising the steps of: performing a primary determination of whether a target object is a golf ball with respect to a first area of a video through an object recognition model; performing a secondary determination of whether the target object is a golf ball on the basis of a shape of the target object with respect to a second area set on the basis of the target object primarily determined to be a golf ball; and performing a final determination of whether the target object is a golf ball with reference to results of the primary determination and the secondary determination.

According to another aspect of the invention, there is provided a system comprising: a primary determination unit configured to perform a primary determination of whether a target object is a golf ball with respect to a first area of a video through an object recognition model; a secondary determination unit configured to perform a secondary determination of whether the target object is a golf ball on the basis of a shape of the target object with respect to a second area set on the basis of the target object primarily determined to be a golf ball; and a final determination unit configured to perform a final determination of whether the target object is a golf ball with reference to results of the primary determination and the secondary determination.

In addition, there are further provided other methods and systems to implement the invention, as well as non-transitory computer-readable recording media having stored thereon computer programs for executing the methods.

According to the invention, it is possible to perform a primary determination of whether a target object is a golf ball with respect to a first area of a video through an object recognition model, perform a secondary determination of whether the target object is a golf ball on the basis of a shape of the target object with respect to a second area set on the basis of the target object primarily determined to be a golf ball, and perform a final determination of whether the target object is a golf ball with reference to results of the primary determination and the secondary determination.

According to the invention, it is possible to detect a golf ball with high accuracy and without errors by complementarily using a learning model for performing object recognition and a detection method for recognizing a golf ball on the basis of its shape, thereby providing a user with an effective golf practice means and the best possible golf play experience.

### BRIEF DESCRIPTION OF THE DRAWINGS

FIG. 1 schematically shows the configuration of an entire system for determining whether a target object in a video is a golf ball according to one embodiment of the invention.

FIG. 2 specifically shows the internal configuration of an object recognition system 200 according to one embodiment of the invention.

FIG. 3 illustratively shows how to recognize an object using a first camera and a second camera in a second embodiment according to one embodiment of the invention.

FIG. 4 illustratively shows how to recognize an object using geometric constraints in the second embodiment according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

### Configuration of the entire system

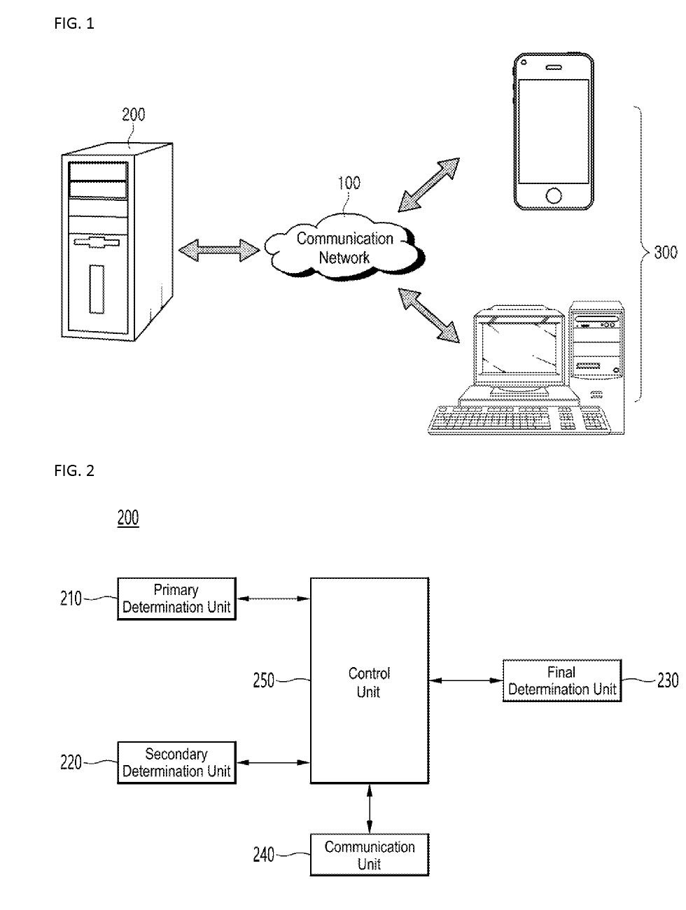

FIG. 1 schematically shows the configuration of the entire system for determining whether a target object in a video is a golf ball according to one embodiment of the invention.

As shown in FIG. 1, the entire system according to one embodiment of the invention may comprise a communication network 100, an object recognition system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the object recognition system 200 according to one embodiment of the invention may function to perform a primary determination of whether a target object is a golf ball with respect to a first area of a video through an object recognition model, perform a secondary determination of whether the target object is a golf ball on the basis of a shape of the target object with respect to a second area set on the basis of the target object primarily determined to be a golf ball, and perform a final determination of whether the target object is a golf ball with reference to results of the primary determination and the secondary determination.

The configuration and functions of the object recognition system 200 according to the invention will be discussed in more detail below.

Next, the device 300 according to one embodiment of the invention is digital equipment capable of connecting to and then communicating with the object recognition system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDA), a web pad, and a mobile phone, may be adopted as the device 300 according to the invention.

In particular, the device 300 may include an application (not shown) for assisting the user to be provided with the services such as determining whether a target object in a video is a golf ball from the object recognition system 200. The application may be downloaded from the object recognition system 200 or an external application distribution server (not shown). Meanwhile, the characteristics of the application may be generally similar to those of a primary determination unit 210, a secondary determination unit 220, a final determination unit 230, a communication unit 240, and a control unit 250 of the object recognition system 200 to be described below. Here, at least a part of the application may be replaced with a hardware device or a firmware device that may perform a substantially equal or equivalent function, as necessary.

### Configuration of the object recognition system

Hereinafter, the internal configuration of the object recognition system 200 crucial for implementing the invention and the functions of the respective components thereof will be discussed.

FIG. 2 specifically shows the internal configuration of the object recognition system 200 according to one embodiment of the invention.

As shown in FIG. 2, the object recognition system 200 according to one embodiment of the invention may comprise a primary determination unit 210, a secondary determination unit 220, a final determination unit 230, a communication unit 240, and a control unit 250. According to one embodiment of the invention, at least some of the primary determination unit 210, the secondary determination unit 220, the final determination unit 230, the communication unit 240, and the control unit 250 may be program modules to communicate with an external system (not shown). The program modules may be included in the object recognition system 200 in the form of operating systems, application program modules, and other program modules, while they may be physically stored in a variety of commonly known storage devices. Further, the program modules may also be stored in a remote storage device that may communicate with the object recognition system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the object recognition system 200 has been described as above, and it will be apparent to those skilled in the art that at least a part of the components or functions of the object recognition system 200 may be implemented in the device 300 or a server (not shown) or included in an external system (not shown), as necessary.

Meanwhile, the object recognition system 200 according to one embodiment of the invention and the primary determination unit 210, the secondary determination unit 220, the final determination unit 230, the communication unit 240, and the control unit 250 included therein may perform the same or different functions in two embodiments separated as a first embodiment and a second embodiment below. Hereinafter, the first and second embodiments will be described in order.

### First embodiment

First, the first embodiment will be described with respect to the functions that may be performed by the primary determination unit 210, the secondary determination unit 220, the final determination unit 230, the communication unit 240, and the control unit 250 according to one embodiment of the invention.

First, the primary determination unit 210 according to one embodiment of the invention may function to perform a primary determination of whether a target object is a golf ball with respect to a first area of a video through an object recognition model.

The first area according to one embodiment of the invention may refer to the entire area where a golf ball may be positioned during golf play. Specifically, the first area may refer to the entire area where a golf ball may be positioned before and after a user hits the golf ball through a swing during golf play. For example, the first area may refer to a mat where the golf ball is placed or the entire "ready zone" where the user (or golfer) prepares to hit the golf ball (e.g., for a tee shot or putting).

The primary determination according to one embodiment of the invention may refer to a process of determining which of all objects existing in the first area is a golf ball through an object recognition model. Specifically, the object recognition model is a deep learning-based model, which may refer to a model that identifies a position (or bounding box) and a type (or class) of an object in an image or video. Generally, the object recognition model receives an image from a camera or video, extracts features of an object from the image through a convolutional neural network (CNN) or the like, predicts a bounding box representing a position of the object, and then recognizes the object through a process of determining a type of the object in the bounding box.

Specifically, the object recognition model according to one embodiment of the invention is a model trained on the basis of video data on golf balls and video data on surrounding objects, and may refer to an artificial intelligence model trained to classify and recognize whether the target object is a golf ball or a surrounding object.

As described above, the object recognition model according to one embodiment of the invention may refer to a deep learning-based model that identifies a position and a type of an object in an image or video.

Specifically, the object recognition model according to one embodiment of the invention may utilize both a one-stage object detection model that detects objects in a single neural network execution, or a two-stage object detection model that first finds a region of interest (ROI) and then classifies objects. For example, the one-stage object detection model may be YOLO (You Only Look Once), SSD (Single Shot Multibox Detector), RetinaNet, and the like, and the two-stage object detection model may be Faster R-CNN, Mask R-CNN, and the like.

More specifically, the object recognition model according to one embodiment of the invention may utilize a YOLO model. The YOLO model, which is a one-stage object detection model, may have the advantage of being able to detect objects at a faster speed than conventional methods such as Faster R-CNN. For example, the YOLO model may output final object detection results through an image segmentation step where an inputted image is divided into a grid; a bounding box prediction step where an object is determined if a box predicted by using anchor boxes and a CNN for predicting object positions in each grid cell has confidence at or above a certain level; a class prediction step where the neural network predicts a type of object for each bounding box; and a non-maximum suppression step where redundant boxes are removed to leave only the box with the highest confidence to prevent predicting the same object with multiple boxes.

The video data according to one embodiment of the invention is a video of the first area photographed by a camera, and may refer to a video that includes a golf ball and surrounding objects other than the golf ball. For example, the video data may refer to a video of the first area photographed by a swing camera for photographing the user's swing or a ball camera for mainly photographing the golf ball, but the type of camera is not limited to these examples. The camera that photographs the first area may refer to at least one camera or a plurality of cameras, as necessary.

The surrounding objects according to one embodiment of the invention may refer to objects that are not golf balls among one or more objects included in the first area. Specifically, the main objective of the object recognition system 200 according to one embodiment of the invention may be to classify and recognize a golf ball and surrounding objects among one or more objects included in the first area. More specifically, the surrounding objects may refer to objects that may be generally positioned around a golf ball during golf play, or objects among these that have a round shape and are relatively similar in shape to a golf ball. For example, the surrounding objects may be a toe part of a user's (or golfer's) shoe, a golf club (or its head part), and the like.

The object recognition model according to one embodiment of the invention may perform learning on visual features of the golf ball, which is the target object to be detected.

The visual features are specific patterns and features of an object included in an image or video, and may include various characteristics such as shape, texture (e.g., dimple patterns of a golf ball), color, size, background (e.g., since golf balls are mostly positioned near grass, bunkers, or golf clubs, context or relationship with such backgrounds may be learned), shadows, reflected light (e.g., highlight patterns due to light reflection), and movement (e.g., a golf ball has no movement before a swing but moves rapidly after the swing).

Further, the object detection model used to perform the primary determination according to one embodiment of the invention may be a model that learns not only the visual features of the golf ball (i.e., the target object), but also visual features of the surrounding objects. Specifically, while conventional object detection models mainly learn only the visual features of a golf ball to detect objects whose features match those features in an image or video, the object detection model according to one embodiment of the invention may detect a golf ball with higher accuracy by learning both the visual features of the golf ball and the visual features of the surrounding objects during the training process. More specifically, the surrounding objects subject to additional training are objects other than the golf ball among the objects existing in the first area as described above, and may refer to various objects that may be positioned in the ready zone. Even more specifically, the surrounding objects subject to additional training are objects having a shape relatively similar to a golf ball as described above, and may be at least one of a shoe toe and a head part of a golf club. The shoe toe and the golf club head part are surrounding objects that are somewhat similar in shape to a golf ball and are often falsely detected as golf balls due to light reflection or only partial regions being separately recognized. The object detection model according to one embodiment of the invention may maximize golf ball detection accuracy by learning the visual features of these surrounding objects (i.e., shoe toe and golf club head part).

In particular, in the training process of the object detection model according to one embodiment of the invention, classifying the golf ball and the surrounding objects may be divided into (i) a case where the training is performed by classifying the golf ball and the non-golf ball surrounding objects, and (ii) a case where the training is performed by classifying three types of objects, i.e., the golf ball, shoe, and club. The object detection model according to one embodiment of the invention may perform the training by using each of cases (i) and (ii), but when the training is performed by classifying objects as in case (ii), golf ball detection accuracy may be higher compared to case (i).

Consequently, the object detection model according to one embodiment of the invention may maximize computational efficiency and golf ball detection accuracy by learning visual features for three types of objects consisting of the golf ball, the user's (or golfer's) shoe (shoe toe), and the club head (i.e., case (ii)). That is, while model accuracy increases as the amount of training data increases in general, the object detection model according to one embodiment of the invention may achieve higher golf ball detection accuracy by additionally learning only two of the surrounding objects (i.e., the user's shoe and the club head) compared to cases where all surrounding objects are learned.

Further, the object detection model according to one embodiment of the invention may calculate a probability of each of one or more detection target objects being a golf ball. That is, the object detection model may learn visual features of a golf ball as described above and may calculate a probability of a specific object being a golf ball before deriving a conclusion that the specific object is a golf ball on the basis of the visual features. The calculated probability may be used in the process of determining whether the specific object is a golf ball, e.g., by determining the object with the highest probability of being a golf ball among several objects as a golf ball.

Meanwhile, in some cases, the object detection model may recognize one detection target object as two separate objects and calculate a probability of being a golf ball for each object (e.g., recognizing the left and right parts of a golf ball separately as golf balls). In this case, the positions of the two objects, i.e., the bounding boxes of the objects will overlap and the objects are determined to be the same object at the same position if the overlapping extent is at or above a certain level (or threshold value), and the object (or its bounding box) with the higher probability of being a golf ball may be determined as the golf ball (i.e., the bounding box with the higher probability is determined to be the actual position of the golf ball).

Further, the object detection model according to one embodiment of the invention may derive a center point for the object determined to be a golf ball, may calculate a size (e.g., diameter or radius information) of the object determined to be the golf ball with respect to the center point, and may additionally verify whether the object is a golf ball by comparing the calculated size with a preset range (i.e., a typical golf ball size). The verification using the size may be performed as part of an inference process of the object recognition model, or may be performed separately from the inference process of the object recognition model before the secondary determination process. For example, in the case where the verification is performed separately from the inference process of the object recognition model, the object detection model detects a golf ball through visual features of an object in the primary determination process, and then calculates a diameter or radius of the object determined to be a golf ball to additionally verify whether the object is a golf ball, thereby further improving detection accuracy.

The training data used for training of the object detection model according to one embodiment of the invention may be reinforced through data augmentation, allowing for additional training beyond the limits of golf ball data that may be actually collected. Specifically, training through data augmentation may be performed by variously transforming data on a video or image of a golf ball to increase data diversity and utilizing the data for the training. Specifically, the data augmentation may be performed by transforming the data in various ways, such as cropping parts of the video or image of the golf ball, changing RGB colors, applying noise filters, rotating the video or image, changing the background, obscuring parts through synthesis, changing brightness, changing 3D tilt, compressing the video or image, or stretching the ratio of the video or image. If a model is trained only with general videos or images of golf balls, the accuracy of detecting a golf ball hidden by grass may be low. However, when the data transformed through the data augmentation is also used as training data, the object recognition model may accurately detect even a golf ball hidden by grass.

The object detection model according to one embodiment of the invention may use an actual user's golf play data (i.e., usage data) that may be acquired in the process of using the object recognition system 200 according to one embodiment of the invention as training data. Specifically, video or image data on golf balls that may be acquired during the golf ball recognition process (i.e., inference process) by the object recognition system 200 may be used for the additional training process of the object detection model. For example, when the object recognition system 200 according to one embodiment of the invention is applied to a virtual golf simulator, data on videos or images of golf balls photographed by a swing camera or ball camera may be additionally acquired, and the golf ball detection accuracy of the object recognition model may be continuously improved in proportion to the user's usage by periodically transmitting the acquired data to the object detection model (e.g., transmitting the data via a network if the object detection model is stored on an external server) and performing additional training using this data.

Next, the secondary determination unit 220 according to one embodiment of the invention may function to perform a secondary determination of whether the target object is a golf ball on the basis of a shape of the target object with respect to a second area set on the basis of the target object primarily determined to be a golf ball.

The second area according to one embodiment of the invention may refer to a partial area formed around an object determined to be a golf ball in the primary determination process. The second area may refer to an area that is included in and smaller than the first area, and includes an area where the golf ball is determined to be positioned in the primary determination process.

Specifically, the second area may refer to a bounding box (or bbox) formed around an object determined to be a golf ball in the primary determination process. The bounding box may refer to a circular or polygonal (e.g., rectangular) region that defines a position of an object in object detection.

For example, a rectangular bounding box may be set by calculating the left/right and top/bottom edges with respect to the center of the golf ball to create a rectangle. Specifically, the rectangular bounding box may be set through the process of (i) detecting a golf ball and finding its center coordinates, (ii) calculating the top-left and bottom-right coordinates with respect to the center of the golf ball to set the bounding box, and (iii) visualizing the bounding box.

According to one embodiment of the invention, the secondary determination of whether the target object is a golf ball may refer to a process of re-detecting a golf ball only with respect to the second area, which is set for the object determined to be a golf ball according to the primary determination.

In the secondary determination process according to one embodiment of the invention, the secondary determination of whether the target object is a golf ball on the basis of a shape of the target object may mean determining whether the target object is a golf ball on the basis of a mathematical algorithm-based method for determining whether an object is a golf ball considering that a golf ball is circular.

That is, the mathematical algorithm-based method detects a golf ball using its shape like the object recognition model described above, but the method is not based on deep learning but based on a mathematical algorithm. Thus, it should be distinguished from the case where the shape of the golf ball is included in various visual features of the golf ball that the object recognition model learns in the primary determination process.

Specifically, in the secondary determination process, a golf ball may be detected using at least one of a Hough circle transform and a contour detection method. The Hough transform is a method of detecting a circular object such as a golf ball by analyzing the edges of an image to find the center and radius of a circle, and the contour detection method may refer to a method of detecting a circular object by preprocessing an image (e.g., applying grayscale and blur), detecting contours through a binarization process, and then selecting a circular object. However, the golf ball detection methods that may be used in the secondary determination process are not limited to the above examples, but any mathematical algorithm-based circular object detection method may be used.

The mathematical algorithm-based golf ball detection method detects a golf ball using its shape (i.e., circular shape) while the deep learning-based object recognition model detects an object by learning not only the circular shape but also overall visual features of an image (i.e., color, pattern, texture, and background information in addition to the shape), and thus they may be distinguished from each other.

That is, together with the primary determination process where a golf ball is detected using a deep learning-based object recognition model with respect to the first area, the object recognition system 200 according to one embodiment of the invention may additionally perform the secondary determination process where a golf ball is re-detected using a mathematical algorithm-based golf ball detection method (i.e., a method of detection based on the shape of the golf ball) with respect to the second area set in the primary determination process, and may use both results of the primary determination and the secondary determination derived therefrom to maximize golf ball detection accuracy.

Specifically, the primary determination unit 210 according to one embodiment of the invention may derive a first center point of the target object that is primarily determined to be a golf ball through the object recognition model, and the secondary determination unit 220 may derive a second center point of the target object that is secondarily determined to be a golf ball on the basis of its shape.

The first center point according to one embodiment of the invention may refer to a center point of an object detected as a golf ball in the primary determination process. The center point according to one embodiment of the invention may refer to the coordinates where the detected golf ball is positioned, meaning the center of the golf ball (which is circular or spherical), or may refer to the coordinates of the center of a bounding box generated around the object detected as a golf ball.

The second center point according to one embodiment of the invention may refer to a center point of an object detected as a golf ball in the secondary determination process. Specifically, since a circular object is detected as a golf ball in the secondary determination process, the second center point may refer to the center (or its coordinates) of a circle or sphere.

More specifically, the primary determination unit 210 according to one embodiment of the invention may primarily determine whether the target object is a golf ball with respect to a first area of a video photographed by a first camera through the object recognition model, and further photograph the target object with a second camera in response to the target object being primarily determined to be a golf ball, and may determine 3D coordinates of a first center point of the target object on the basis of the video photographed by the first camera and the video photographed by the second camera, wherein the first camera and the second camera may have different views.

That is, the primary determination according to one embodiment of the invention may be performed by analyzing a video or image with respect to a first area acquired by one camera through the object recognition model, but a camera other than the above camera may be further used to derive coordinates of a center of an object determined to be a golf ball through the primary determination.

Specifically, the video or image to be analyzed through the primary determination may be acquired through the first camera. Separately, the first area may be further photographed using a camera with a view different from the view of the first camera, so that 3D coordinates of an object determined to be a golf ball in the primary determination process may be determined.

The second camera according to one embodiment of the invention may have a view different from the view of the first camera, so that 3D coordinates of an object may be calculated using a difference between the viewpoints (or views) of the two cameras.

Specifically, calculating 3D coordinates of an object using the difference between the viewpoints of the two cameras may be performed using triangulation. The triangulation may refer to a method of calculating 3D coordinates of a target object, which includes placing two cameras at a certain distance apart, photographing the same target object with the two cameras, analyzing disparity of the target object, and applying trigonometry to calculate depth of the object. The disparity (or parallax) is a numerical value indicating how differently the same object is positioned in the views of the two cameras, and the 3D coordinates may be calculated using the principle that the object is close if the disparity is large, and the object is far if the disparity is small.

That is, the primary determination process according to one embodiment of the invention may be performed by first analyzing a video or image acquired through the first camera with the object recognition model to detect a golf ball, and in response to a specific object being determined to be a golf ball, further using the second camera to calculate 3D coordinates of the object determined to be a golf ball through triangulation, thereby allowing the first camera and the second camera to be used sequentially or conditionally. That is, by using the two cameras sequentially or conditionally as described above, it is possible to prevent power waste and a decrease in analysis efficiency that occur when two cameras are always operating simultaneously.

Meanwhile, the first camera and the second camera may be embedded within a single device at a certain distance apart, or may be separately provided in separate devices and placed at a specific distance apart.

Specifically, the secondary determination unit 220 according to one embodiment of the invention may determine 2D coordinates of the second center point.

The 2D coordinates of the second center point according to one embodiment of the invention may refer to coordinates of a center of a circular object detected as a golf ball as a result of the secondary determination as described above. That is, unlike the center coordinates of the first center point being calculated as 3D coordinates on the basis of triangulation, the center coordinates of the second center point may refer to 2D coordinates of a center point of a circular object detected in the second area (or bounding box).

Specifically, the second area according to one embodiment of the invention may refer to a region that includes the target object primarily determined to be a golf ball and is relatively narrow compared to the first area.

The second area according to one embodiment of the invention is a partial region included in the first area, and may refer to a region related to the region where the object determined to be a golf ball in the primary determination process is positioned (or a bounding box generated around the object). Since this second area has already been described above, its description is omitted to avoid excessive redundancy.

Next, the final determination unit 230 according to one embodiment of the invention may function to perform a final determination of whether the target object is a golf ball with reference to results of the primary determination and the secondary determination.

Finally determining whether the target object is a golf ball by the final determination unit 230 according to one embodiment of the invention may mean comprehensively using the results of the primary determination and the secondary determination to finally calculate whether the target object is a golf ball.

Specifically, the final determination unit 230 according to one embodiment of the invention may finally determine whether the target object is a golf ball with reference to the first center point and the second center point derived above.

The final determination unit 230 according to one embodiment of the invention may finally determine whether the target object is a golf ball by comparing the center coordinates (which are 3D coordinates) of the object determined to be a golf ball in the primary determination process and the center coordinates (which are 2D coordinates) of the object determined to be a golf ball in the secondary determination process.

Specifically, the final determination unit 230 according to one embodiment of the invention may finally determine whether the target object is a golf ball with reference to values of two corresponding dimensions among the 3D coordinates of the first center point determined above and the 2D coordinates of the second center point determined above.

The values of two corresponding dimensions among the 3D coordinates of the first center point and the 2D coordinates of the second center point may refer to the values of two coordinates of the same dimension. Specifically, when the first center point has 3D coordinates (consisting of the x-axis, y-axis, and z-axis and derived by triangulation) of the object determined to be a golf ball in the actual space, and the second center point has 2D coordinates (consisting of the x-axis and y-axis) of the object determined to be a golf ball in the secondary determination process performed with respect to the 2D second area, the values of the coordinates of the remaining two dimensions (e.g., x-axis and y-axis) excluding the depth information (e.g., z-axis) included in the 3D coordinates may be the values of the two corresponding dimensions.

Specifically, the final determination unit 230 according to one embodiment of the invention may finally determine the target object to be a golf ball if the similarity of the values of the two dimensions is not less than a threshold value.

In addition to the case where the values of the two corresponding dimensions in the first center point and the second center point are the same as described above, it is possible to finally determine whether the target object is a golf ball on the basis of a threshold value set for the similarity of these values. That is, even if the values of the two dimensions do not perfectly match, the object may be finally determined to be a golf ball if the values are similar at or above a certain extent.

Specifically, the threshold value for the similarity may be determined in consideration of various factors such as an environment or conditions of the space where the golf ball to be recognized is positioned (e.g., the first area), performance of hardware on which the object recognition system 200 according to one embodiment of the invention operates, and an amount of computational processing that may be allocated by the hardware.

As the threshold value has a higher value, the probability that the object determined to be a golf ball by the object recognition system 200 according to one embodiment of the invention is an actual golf ball may increase while the amount of computational processing or the required hardware performance may become excessively high. As the threshold value has a lower value, the amount of computational processing or the required hardware performance may be reduced so that the object recognition system may operate in various hardware environments, but golf ball detection accuracy may become excessively low. Therefore, the threshold value may be determined as an optimal value in consideration of the various factors described above.

For example, when the object recognition system 200 according to one embodiment of the invention is applied to an indoor virtual golf simulator, surrounding objects other than the golf ball may be very limited to the user (or the user's shoes), the golf club head, and the like. In such cases, the probability of being mistakenly recognized as a golf ball is relatively low, so that the threshold value may be set relatively low.

Meanwhile, if the environment affecting golf ball recognition accuracy (e.g., brightness of lighting) is different even for the same indoor virtual golf simulator, this may be considered in setting the threshold value. For example, if the lighting in the environment is too bright or too dark so that it is difficult to recognize the golf ball, the threshold value may be set relatively high. Further, when the object recognition system 200 according to one embodiment of the invention is applied outdoors (e.g., an actual golf course), there are many more objects other than the golf ball compared to indoors, and there are many environmental factors that interfere with golf ball recognition (e.g., grass), and the possibility of continuously changing weather or illuminance is high, making it much more difficult to accurately recognize a golf ball, so that the threshold value may be set high in consideration of the foregoing.

Consequently, the object recognition system 200 according to one embodiment of the invention may maximize the accuracy of finally detecting the golf ball by complementarily using a deep learning-based object recognition model and a general analog detection method (i.e., the secondary determination method for determining whether the target object is a golf ball on the basis of its shape as described above, which is a mathematical algorithm-based circular object detection method).

Next, the communication unit 240 according to one embodiment of the invention may function to enable data transmission/reception from/to the primary determination unit 210, the secondary determination unit 220, and the final determination unit 230.

Lastly, the control unit 250 according to one embodiment of the invention may function to control data flow among the primary determination unit 210, the secondary determination unit 220, the final determination unit 230, and the communication unit 240. That is, the control unit 250 according to one embodiment of the invention may control data flow into/out of the object recognition system 200 or data flow among the respective components of the object recognition system 200, such that the primary determination unit 210, the secondary determination unit 220, the final determination unit 230, and the communication unit 240 may carry out their particular functions, respectively.

### Second embodiment

Hereinafter, the second embodiment will be described with respect to the functions that may be performed by the primary determination unit 210, the secondary determination unit 220, the final determination unit 230, the communication unit 240, the control unit 250, and the reverification unit (not shown) according to one embodiment of the invention. Meanwhile, unless otherwise specified, the descriptions of the second embodiment may be understood as being the same or substantially the same as those of the first embodiment.

First, the primary determination unit 210 according to one embodiment of the invention may function to perform a primary determination of whether at least one target object included in a video of a specific area photographed by a first camera is a golf ball.

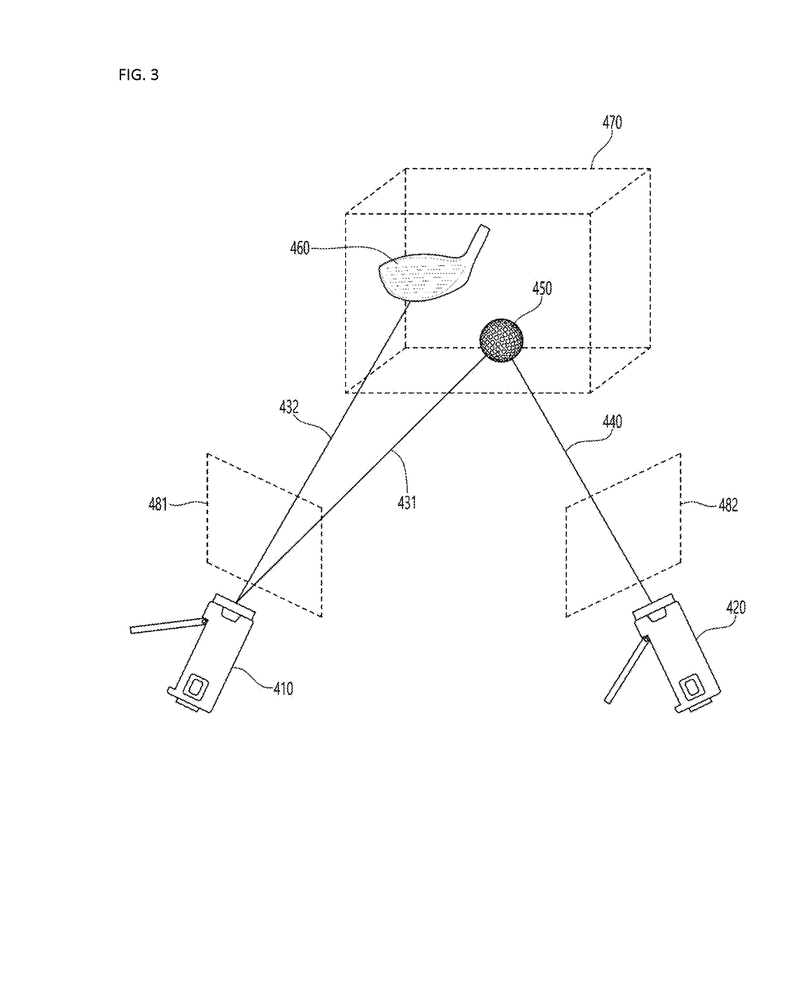

The specific area according to one embodiment of the invention may refer to the entire area where a golf ball may be positioned during golf play. Specifically, the specific area may refer to the entire area where a golf ball may be positioned before and after a user hits the golf ball through a swing during golf play, which is to be photographed by the first and second cameras to be described below. For example, the specific area may refer to a mat where the golf ball is placed or the entire "ready zone" where the user (or golfer) prepares to hit the golf ball (e.g., for a tee shot or putting). Meanwhile, the specific area may refer to the same area as the first area mentioned in the first embodiment. Referring to FIG. 3, a specific area 470 may refer to a three-dimensional space where at least one target object (e.g., a first target object 450 or a second target object 460) is positioned.

The at least one target object according to one embodiment of the invention may refer to one or more objects positioned in the specific area for which the object recognition model determines whether they are golf balls. Specifically, the at least one target object may be classified into a golf ball and surrounding objects other than the golf ball. The surrounding objects other than the golf ball should be understood as encompassing all types of objects other than the golf ball, and may refer to, for example, objects with visual characteristics relatively similar to those of a golf ball, such as a toe part of a user's (or golfer's) shoe or a golf club (or its head part), as mentioned in the first embodiment.

Next, the secondary determination unit 220 according to one embodiment of the invention may function to perform a secondary determination of whether the at least one target object included in a video of the specific area photographed by a second camera is a golf ball.

Meanwhile, the primary determination process by the primary determination unit 210 and the secondary determination process by the secondary determination unit 220 in the second embodiment may not be in a sequential relationship, but should be understood as independent object recognition processes (i.e., determination processes) performed on videos or images of the same specific area photographed from different views. That is, the primary and secondary determination processes in the second embodiment do not necessarily require one to be performed before the other, but may be performed simultaneously (or with a predetermined time difference). However, even in the second embodiment, at least one of the primary and secondary determination processes may be performed before the other in some cases. That is, the fact that the primary and secondary determination processes are not in a sequential relationship in the second embodiment does not mean that they must be performed simultaneously, but mean that one determination process does not essentially have to precede the other.

Specifically, the first camera and the second camera according to one embodiment of the invention may be different cameras that photograph the specific area from different views.

Further, the first and second cameras are capable of photographing at least one of the golf ball itself, the surrounding objects other than the golf ball, and their movements, and may refer to photographing devices that support high-resolution and high-frame-rate photographing to allow visual features (e.g., rotation, surface patterns, and dimples) or fast movement of a golf ball to be captured. However, the first and second cameras are not limited thereto but should be understood to encompass any device that photographs videos containing sufficient information necessary to analyze the golf ball itself and its movement.

In addition, the first camera and the second camera are independent photographing means and may be provided in the form of two independent photographing devices, but they may also be provided in the form of two different cameras included in a single photographing device. That is, as long as the cameras may independently photograph the same specific area from different views, the form in which they are provided is not limited to the above examples but may be changed in various ways.

Referring to FIG. 3, a first camera 410 and a second camera 420 may refer to two independent cameras placed at a specific distance from each other. Specifically, the first camera 410 and the second camera 420 may be placed such that a first straight line 431 or 432 connecting the first camera 410 (or its center point) and a specific point included in the specific area 470 (which may be a center point of at least one target object) and a second straight line 440 connecting the second camera 420 (or its center point) and a specific point included in the specific area 470 (which may be the center point of the at least one target object) form an angle of 0 to 180 degrees. That is, the first camera 410 and the second camera 420 may refer to independent photographing devices that photograph the same subject (i.e., the specific area 470 and the at least one target object included therein) from different views (i.e., angles). Meanwhile, in FIG. 3, two first straight lines, i.e., the first straight line 431 for the first target object and the first straight line 432 for the second target object are shown as the first straight line, while only the second straight line 440 for the first target object is shown as the second straight line and others are omitted.

Specifically, the object recognition model according to one embodiment of the invention is substantially the same as described in the first embodiment. That is, as in the first embodiment, recognition accuracy may be increased by performing training to classify a golf ball and surrounding objects or classify objects into a golf ball, a shoe, and a club, and by applying data augmentation in the same manner.

However, as described above, the object recognition model in the second embodiment may independently perform object recognition for each of a video of a specific area photographed by the first camera and a video of the same specific area photographed by the second camera.

Here, the fact that the object recognition model performs object recognition independently may mean performing object recognition on the same target object included in the same specific area through the object recognition model with respect to each of two videos or images photographed from different views (or angles). Accordingly, even if the object recognition is performed on the same target object, the object recognition results may differ because the visual characteristics of the object in the two videos or images (e.g., differences in distance, lighting, and brightness) may vary as the photographing angles differ.

For example, referring to FIG. 3, a situation may be assumed in which two target objects exist in the specific area 470, wherein the first target object 450 is actually a golf ball and the second target object 460 is actually a club head. In this situation, as a result of performing object recognition (i.e., primary determination) on the basis of a video of the specific area photographed by the first camera 410, the object recognition model may determine that both the first target object 450 and the second target object 460 are golf balls (i.e., misjudging the club head as a golf ball due to the influence of angle, lighting, and the like). In contrast, as a result of performing object recognition (i.e., secondary determination) on the basis of a video of the specific area photographed by the second camera 420, the object recognition model may determine that only the first target object 450 is a golf ball (i.e., accurately determining only the target object that is actually a golf ball as a golf ball).

Specifically, the primary determination unit 210 according to one embodiment of the invention may function to derive 2D coordinates of a center point of the at least one target object primarily determined to be a golf ball through the object recognition model.

The center point of the target object according to one embodiment of the invention may refer to a coordinate point representing the position of the target object. The method of acquiring the center point of an object varies depending on the method of representing the object, and the center point according to one embodiment of the invention may be acquired by applying all types of methods. For example, the method of acquiring the center point may include (i) a method of calculating the center point using a bounding box, (ii) a method of calculating the center point on the basis of the contour of the object when it is difficult to generate an accurate bounding box due to the object's irregular shape, and (iii) a keypoint-based center point derivation method of deriving the center point by finding and using a specific point that is a characteristic part of the object. Here, unlike method (i), method (iii) may not use the process of predicting a bounding box by predicting the characteristic part of the object itself (e.g., eyes of a face, mouth, and wrists in the case of a person).

Meanwhile, although the first and second cameras according to one embodiment of the invention are not included in the target objects, their center points may be calculated in the same manner as the various methods of calculating the center point of the target object described above, and information on the center points (i.e., information related to the positions of the first and second cameras) and the distance between the first and second cameras (i.e., the distance between their center points) may also be used in the final determination to be described below as information related to extrinsic parameters of the cameras.

That is, the primary determination unit 210 according to one embodiment of the invention may derive the center point and its 2D coordinates of the at least one target object primarily determined to be a golf ball through the object recognition model using the various center point derivation methods described above.

Here, when a video or image of the specific area photographed by the first camera is a 2D plane, the 2D coordinates of the center point of the target object may refer to the 2D coordinates of the center point of the target object in the 2D plane derived as a result of photographing by the first camera.

Further, the secondary determination unit 220 according to one embodiment of the invention may function to derive 2D coordinates of the at least one target object secondarily determined to be a golf ball through the object recognition model.

Here, the meaning of the elements related to the 2D coordinates of the at least one target object secondarily determined is the same as the above description of the primary determination in the second embodiment, and thus the description thereof is omitted to avoid excessive redundancy.

Meanwhile, when a video of the specific area photographed by the second camera is a 2D plane, the 2D coordinates of the at least one target object secondarily determined to be a golf ball may refer to the 2D coordinates of the center point of the target object in the 2D plane derived as a result of photographing by the second camera. That is, the 2D coordinates of the target object derived in the primary determination process and the 2D coordinates of the target object derived in the secondary determination process are coordinates in different 2D planes, and thus the values of the 2D coordinates may differ from each other even for the same target object.

Referring to FIG. 3, while the specific area 470 is a 3D space, a first image 481 generated as a result of photographing the specific area 470 by the first camera 410 and a second image 482 generated as a result of photographing the specific area 470 by the second camera 420 may be 2D planes. Therefore, even for the same target object, the values of the coordinates of the target object (i.e., the 2D coordinates of the center point of the target object) projected onto the first image 481 and the second image 482 may be different.

Meanwhile, the first image 481 and the second image 482 may be a single 2D image or a 2D video including a plurality of 2D images.

Next, the final determination unit 230 according to one embodiment of the invention may function to perform a final determination of whether the at least one target object is a golf ball with reference to results of the primary determination and the secondary determination.

As described above, referring to the results of the primary determination and the secondary determination may mean comprehensively using the primary determination result (or all information that may be acquired during the primary determination process) and the secondary determination result (or all information that may be acquired during the secondary determination process) by, for example, comparing these results in the process of finally determining whether the target object is a golf ball.

Meanwhile, the final determination unit 230 according to one embodiment of the invention may perform the final determination by further using information related to intrinsic parameters and extrinsic parameters of the first camera and the second camera.

Specifically, the intrinsic parameters may refer to variables that describe optical characteristics inside the camera. Specifically, the intrinsic parameters may refer to variables related to the camera's own lens, focal length, image sensor size, and the like. For example, the intrinsic parameters may refer to focal length, a principal point, lens distortion coefficients, a camera matrix, and the like.

Specifically, the extrinsic parameters may refer to geometric information like the position and orientation of the camera. While the intrinsic parameters generally have fixed values, the extrinsic parameters may change according to the movement of the camera. As described above, the positions of the first and second cameras (i.e., the coordinates of the center points of the first and second cameras), the distance therebetween, parallax, and the like may be used in the final determination as information related to the extrinsic parameters.

Specifically, the final determination unit 230 according to one embodiment of the invention may finally determine whether the target object is a golf ball with reference to information on a geometric relationship between the 2D coordinates of the center point of the at least one target object primarily determined and the 2D coordinates of the center point of the at least one target object secondarily determined.

Further, the information on the geometric relationship may refer to all types of information on a geometric relationship between a video or image of a specific area (or at least one target object included therein) photographed by the first camera and a video or image of the specific area (or the at least one target object included therein) photographed by the second camera. Specifically, the information on the geometric relationship may refer to all types of information related to epipolar geometry, which is a mathematical model describing a geometric relationship between two videos when two cameras photograph the same subject from different angles.

Specifically, the information related to epipolar geometry may refer to information on a geometric relationship between matching pairs of points existing on two photographed 2D planes (i.e., results of photographing acquired by different cameras) when the same object is photographed from two different points.

The matching pair may refer to a pair of two coordinate points existing at different 2D coordinates when one 3D coordinate point is projected onto two different 2D planes. That is, the matching pair may refer to a pair of two 2D coordinates formed by projecting the coordinates of a center point of a single target object existing in an actual 3D space onto two 2D plane videos or images photographed from different views.

Specifically, the information on the geometric relationship may include information on geometric constraints that occur on the basis of the fact that the at least one target object included in the specific area respectively photographed by the first camera and the second camera is the same object.

Further, the geometric constraint is one of the characteristics related to epipolar geometry, meaning that when finding a position of one coordinate point of the matching pair on another 2D coordinate, the part where that coordinate point may be positioned is restricted. Specifically, as a result of photographing the same target object from different angles, a point in an actual 3D space is projected into different 2D coordinate points. When finding a matching pair for a specific point "a" of a first 2D plane (e.g., an image of a specific area photographed by the first camera) in a second 2D plane (i.e., an image of the specific area photographed by the second camera), the geometric principle that the coordinates of the specific point "a" of the first 2D plane in the second 2D plane (i.e., the coordinates of the matching pair) may only exist on an epipolar line may be an epipolar constraint.

Meanwhile, the process of finding a specific point corresponding to the specific point "a" of one 2D plane in another 2D plane may be referred to as feature matching, through which object recognition may be performed by restoring information on a 3D object from 2D images. Here, due to the epipolar constraint, a specific point of one 2D plane cannot be positioned at any coordinate on another 2D plane, but must exist only on an epipolar line defined on the other 2D plane. Therefore, feature matching may be easily performed by finding only the epipolar line without needing to search the entire 2D plane (i.e., the entire image) during the process of feature matching. Thus, objects may be recognized faster and more accurately by reducing the search space using the epipolar constraint.

Further, the final determination unit 230 according to one embodiment of the invention may finally determine whether the at least one target object is a golf ball using the epipolar constraint and epipolar line.

Feature matching may be performed after performing object recognition using the epipolar constraint, and triangulation may be carried out on the basis of matching pairs in a single 2D video or image to acquire depth information (i.e., 3D coordinates of the target object in a 3D space). However, the final determination unit 230 according to one embodiment of the invention may omit the process of acquiring 3D coordinates and improve object recognition accuracy using the epipolar constraint together with the primary and secondary determination results as will be described below.

Specifically, improving object recognition accuracy using the epipolar constraint together with the primary and secondary determination results may involve: (i) performing object recognition on a 2D plane image photographed by the first camera to determine whether at least one target object is a golf ball (i.e., primary determination), (ii) performing object recognition on a 2D plane image photographed by the second camera to determine whether the at least one target object is a golf ball (i.e., secondary determination), (iii) calculating an epipolar line of the object determined to be a golf ball in (i) on the 2D plane image photographed by the second camera, and (iv) comparing a center point of the object determined to be a golf ball in (ii) with the epipolar line calculated in (iii) to finally determine whether the target object is a golf ball (i.e., final determination) without the process of calculating 3D coordinates.

That is, the final determination unit 230 according to one embodiment of the invention may finally determine whether the target object is a golf ball on the basis of a distance between the epipolar line and the coordinates of the center point of the golf ball. For example, if there are a plurality of epipolar lines (i.e., if a plurality of target objects are determined to be golf balls in step (i)), distances between the center point of the object determined to be a golf ball as a result of object recognition for the 2D plane image photographed by the second camera and the plurality of epipolar lines are respectively derived, and the object with the shorter distance is commonly determined as a golf ball in both the primary determination and the secondary determination, so that the target object may be finally determined as a golf ball.

That is, according to the second embodiment, even when it is difficult to make a final determination because results of object recognition for images photographed by the two cameras are different, it is possible to efficiently determine which target object is a golf ball according to the process described above. When recognizing objects in this manner, the calculation process for deriving 3D coordinates of an actual target object performed in the first embodiment may be omitted, thereby improving the calculation speed and efficiency in the object recognition process.

Even when only one target object is determined to be a golf ball in the primary determination and only one epipolar line is derived, the calculation speed and efficiency may also be improved because it may be immediately determined that the target object is a golf ball without additional calculation processes, if the epipolar line is close to the center point of the object determined to be a golf ball as a result of object recognition for the 2D plane image photographed by the second camera.

Further, in the training process of the object recognition model used in the second embodiment, the method of training the object recognition model by classifying objects into a golf ball, shoe, and club as mentioned in the first embodiment may also be applied to maximize the calculation speed and efficiency. That is, in the second embodiment, in addition to using the geometric constraints, object recognition accuracy may be improved by applying the object classification and the training reinforcement through data augmentation in the training process of the object recognition model.

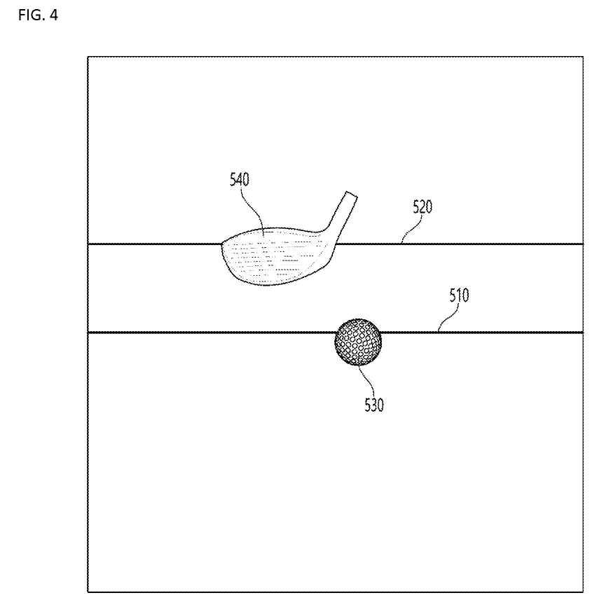

Meanwhile, assuming a situation in which there are two target objects in a specific area, each step performed up to the final determination will be described on the basis of FIGS. 3 and 4. Specifically, there are two target objects, i.e., a first target object (450 in FIG. 3 and 530 in FIG. 4) and a second target object (460 in FIG. 3 and 540 in FIG. 4) in the specific area 470 which is an actual 3D space. Here, 450 in FIG. 3 and 530 in FIG. 4 are the same target object and correspond to an actual golf ball, while 460 in FIG. 3 and 540 in FIG. 4 are the same target object and correspond to a head part of a club.
(i) First, a first image 481, which is a 2D image, is acquired by photographing the 3D specific area 470 with the first camera 410, and a second image 482, which is a 2D image, is acquired by photographing the same specific area 470 from a different angle (or view) with the second camera 420.
(ii) Next, object recognition is performed independently for each of the first image 481 and the second image 482 using an object recognition model, and at least one target object determined to be a golf ball as a result of the object recognition may be specified.
(iii) Next, with respect to the target objects determined to be golf balls as a result of performing object recognition on the first image 481, corresponding epipolar lines (510 and 520 in FIG. 4) may be projected onto the second image (482 in FIG. 3 and 500 in FIG. 4). In this example, as a result of performing object recognition on the first image, both the first target object and the second target object are determined to be golf balls. Here, the epipolar line of the first target object 450 corresponds to the first epipolar line 510 in FIG. 4, and the epipolar line of the second target object 460 corresponds to the second epipolar line 520 in FIG. 4.
(iv) Next, distances between the object 530 determined to be a golf ball as a result of object recognition performed on the second image 482 and the two epipolar lines 510 and 520 may be calculated. The distances may be calculated as the shortest distances between the coordinates of the center point of the object 530 determined to be a golf ball and the epipolar lines. Here, as a result of the secondary determination with respect to the second image, the first target object 530 is determined to be a golf ball and the second target object 540 is determined not to be a golf ball.
(v) By comparing the distances calculated in (iv), the target object commonly determined to be a golf ball in step (i) (i.e., primary determination) and step (ii) (i.e., secondary determination) may be finally determined to be a golf ball. That is, both the target objects are determined to be golf balls in step (i), but it may be finally determined with reference to the results of step (ii) (i.e., using the distances between the epipolar lines and the center point) that the second target object 460 or 540 is not a golf ball and the first target object 450 or 530 is the actual golf ball.

Meanwhile, the descriptions of the processes performed up to the final determination are merely exemplary, and the details of the specific tasks performed in each step, the order of the steps, and the like may be changed as long as they are consistent with the objects of the invention.

Further, in the second embodiment, the object recognition system 200 according to one embodiment of the invention may further comprise a reverification unit (not shown).

The reverification unit (not shown) according to one embodiment of the invention may function to additionally reverify whether the target object finally determined to be a golf ball according to the final determination result of the final determination unit 230 is a golf ball.

Specifically, the reverification unit (not shown) according to one embodiment of the invention may function to calculate 3D coordinates of a center point of the target object finally determined to be a golf ball by the final determination unit 230, calculate 2D coordinates of the center point of the target object finally determined to be a golf ball on the basis of a shape of the target object, and then additionally reverify whether the target object finally determined to be a golf ball is a golf ball with reference to the calculated 3D coordinates and the calculated 2D coordinates.

More specifically, the process of calculating the 3D coordinates may be performed through a method using a position difference (i.e., parallax) between the two cameras photographing the target object, and the process of calculating the 2D coordinates may be performed through a method of setting a bounding box for the target object determined to be a golf ball and determining whether the target object is a golf ball on the basis of its shape with respect to the set bounding box (i.e., a mathematical algorithm-based method).

Here, among the functions of additionally reverifying whether the target object is a golf ball by the reverification unit (not shown), calculating the 3D coordinates of the center point of the target object may be performed in the same manner as the primary determination process (i.e., the method of determining 3D coordinates in the primary determination process) by the primary determination unit 210 in the first embodiment described above, and calculating the 2D coordinates of the center point of the target object on the basis of the shape of the target object may be performed in the same manner as the secondary determination process (i.e., the method of determining 2D coordinates in the secondary determination process) by the secondary determination unit 220 in the first embodiment described above.

In summary, in the second embodiment, the primary determination unit 210 and the secondary determination unit 220 basically perform object recognition on the target object on the basis of an object recognition model, and the final determination unit 230 may determine whether the target object is a golf ball on the basis of the object recognition results (i.e., the primary and secondary determination results) of the primary determination unit 210 and the secondary determination unit 220. However, the reverification unit (not shown) may improve object recognition accuracy as necessary by performing an additional process of reverifying whether the target object is a golf ball on the basis of its shape with respect to the determination result of the final determination unit 230. That is, while the final determination process by the final determination unit 230 alone may determine whether the target object is a golf ball with high accuracy and speed, the reverification unit (not shown) may maximize object recognition accuracy by reviewing once more whether the target object is a golf ball as necessary.

Meanwhile, depending on the environment in which the object recognition system 200 according to one embodiment of the invention is applied, the reverification unit (not shown) may be additionally applied in response to the accuracy according to the object recognition results of the primary determination unit 210, the secondary determination unit 220, and the final determination unit 230 being determined to be low.

For example, (i) in a stable environment with few surrounding objects or variables (e.g., an indoor environment or a golf course), object recognition is performed without applying the reverification unit (not shown), and (ii) in a field or outdoor environment where light reflection is more irregular, the influence of weather (e.g., snow or rain) is greater, and surrounding objects other than golf balls (e.g., grass or surrounding structures) exist more diversely, the reverification unit (not shown) may be applied to further improve object recognition accuracy.

As another example, if it is determined that supplementation of object recognition accuracy is necessary because performance of the cameras used in the object recognition system 200 is limited (e.g., the resolution of the cameras available to the user is low), the reverification unit (not shown) may be additionally applied as described above to further improve object recognition accuracy to a desired extent.

Next, the communication unit 240 according to one embodiment of the invention may function to enable data transmission/reception from/to the primary determination unit 210, the secondary determination unit 220, the final determination unit 230, and the reverification unit (not shown).

Lastly, the control unit 250 according to one embodiment of the invention may function to control data flow among the primary determination unit 210, the secondary determination unit 220, the final determination unit 230, the communication unit 240, and the reverification unit (not shown). That is, the control unit 250 according to one embodiment of the invention may control data flow into/out of the object recognition system 200 or data flow among the respective components of the object recognition system 200, such that the primary determination unit 210, the secondary determination unit 220, the final determination unit 230, the communication unit 240, and the reverification unit (not shown) may carry out their particular functions, respectively.

Meanwhile, unlike conventional golf ball recognition methods, the object recognition methods according to the first and second embodiments described above may recognize a golf ball with high accuracy even in situations where many surrounding objects other than the golf ball exist, where the golf ball is more frequently obscured by surrounding objects (e.g., grass, snow, and structures), or where the irregularity of the surrounding environment (e.g., weather) is much higher, and thus may be used in environments with little change (e.g., indoor environments or golf courses) and may also be applied to analysis equipment (e.g., portable launch monitors) used in situations with significant environmental changes (e.g., fields or outdoor environments), thereby maximizing utility.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks, and magnetic tapes; optical media such as compact disk-read only memory (CD-ROM) and digital versatile disks (DVDs); magneto-optical media such as floptical disks; and hardware devices such as read-only memory (ROM), random access memory (RAM), and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### DESCRIPTION OF THE REFERENCE NUMERALS

100: communication network

200: object recognition system

210: primary determination unit

220: secondary determination unit

230: final determination unit

240: communication unit

250: control unit

300: device

What is claimed is:

1. A method for determining whether a target object in a video is a golf ball, the method comprising the steps of:
performing a primary determination of whether a target object is a golf ball with respect to a first area of a video through an object recognition model;
performing a secondary determination of whether the target object is a golf ball on the basis of a shape of the target object with respect to a second area set on the basis of the target object primarily determined to be a golf ball; and
performing a final determination of whether the target object is a golf ball with reference to results of the primary determination and the secondary determination.

2. The method of claim 1, wherein the object recognition model is a model trained on the basis of video data on golf balls and video data on surrounding objects, wherein the model is an artificial intelligence model trained to classify and recognize whether the target object is a golf ball or a surrounding object.

3. The method of claim 1, wherein in the step of performing the primary determination, a first center point of the target object that is primarily determined to be a golf ball through the object recognition model is derived, and
wherein in the step of performing the secondary determination, a second center point of the target object that is secondarily determined to be a golf ball on the basis of the shape is derived.

4. The method of claim 3, wherein in the step of performing the final determination, whether the target object is a golf ball is finally determined with reference to the derived first center point and the derived second center point.

5. The method of claim 1, wherein the second area is a region that includes the target object primarily determined to be a golf ball and is relatively narrow compared to the first area.

6. The method of claim 3, wherein the step of performing the primary determination comprises the steps of:
primarily determining whether a target object is a golf ball with respect to a first area of a video photographed by a first camera through the object recognition model;
further photographing the target object with a second camera in response to the target object being primarily determined to be a golf ball; and
determining 3D coordinates of a first center point of the target object on the basis of the video photographed by the first camera and the video photographed by the second camera, and
wherein the first camera and the second camera have different views.

7. The method of claim 6, wherein in the step of performing the secondary determination, 2D coordinates of a second center point of the target object are determined.

8. The method of claim 7, wherein in the step of performing the final determination, whether the target object is a golf ball is finally determined with reference to values of two corresponding dimensions among the determined 3D coordinates of the first center point and the determined 2D coordinates of the second center point.

9. The method of claim 8, wherein in the step of performing the final determination, the target object is finally determined to be a golf ball if similarity of the values of the two dimensions is not less than a threshold value.

10. A non-transitory computer-readable recording medium having stored thereon a computer program for executing the method of claim 1.

11. A system for determining whether a target object in a video is a golf ball, the system comprising:
a primary determination unit configured to perform a primary determination of whether a target object is a golf ball with respect to a first area of a video through an object recognition model;
a secondary determination unit configured to perform a secondary determination of whether the target object is a golf ball on the basis of a shape of the target object with respect to a second area set on the basis of the target object primarily determined to be a golf ball; and
a final determination unit configured to perform a final determination of whether the target object is a golf ball with reference to results of the primary determination and the secondary determination.

12. A method for determining whether a target object in a video is a golf ball, the method comprising the steps of:
performing a primary determination of whether at least one target object included in a video of a specific area photographed by a first camera is a golf ball;
performing a secondary determination of whether the at least one target object included in a video of the specific area photographed by a second camera is a golf ball; and
performing a final determination of whether the at least one target object is a golf ball with reference to results of the primary determination and the secondary determination,
wherein the primary determination and the secondary determination are performed through an object recognition model.

13. The method of claim 12, wherein the object recognition model is a model trained on the basis of video data on golf balls and video data on surrounding objects, wherein the model is an artificial intelligence model trained to classify and recognize whether the target object is a golf ball or a surrounding object.

14. The method of claim 12, wherein the first camera and the second camera are different cameras that photograph the specific area from different views.

15. The method of claim 12, wherein in the step of performing the primary determination, 2D coordinates of a center point of the at least one target object that is primarily determined to be a golf ball through the object recognition model are derived, and
wherein in the step of performing the secondary determination, 2D coordinates of a center point of the at least one target object that is secondarily determined to be a golf ball through the object recognition model are derived.

16. The method of claim 15, wherein in the step of performing the final determination, whether the target object is a golf ball is finally determined with reference to information on a geometric relationship between the 2D coordinates of the center point of the at least one target object primarily determined and the 2D coordinates of the center point of the at least one target object secondarily determined.

17. The method of claim 16, wherein the information on the geometric relationship includes information on geometric constraints that occur on the basis of a fact that the at least one target object included in the specific area photographed by the first camera and the second camera is the same object.

18. A non-transitory computer-readable recording medium having stored thereon a computer program for executing the method of claim 12.

19. A system for determining whether a target object in a video is a golf ball, the system comprising:
a primary determination unit configured to perform a primary determination of whether at least one target object included in a video of a specific area photographed by a first camera is a golf ball;
a secondary determination unit configured to perform a secondary determination of whether the at least one target object included in a video of the specific area photographed by a second camera is a golf ball; and
a final determination unit configured to perform a final determination of whether the at least one target object is a golf ball with reference to results of the primary determination and the secondary determination,
wherein the primary determination and the secondary determination are performed through an object recognition model.
